(19) United States
(12) Patent Application Publication
(10) Pub. No.: US 2025/0123178 A1
(43) Pub. Date: Apr. 17, 2025

(54) Method for the Discrete Calculation of HUD Optics and Evaluation of the HUD Performance of a Vehicle Window

(71) Applicant: Bayerische Motoren Werke Aktiengesellschaft, Muenchen (DE)

(72) Inventors: Tobias SOLCHENBACH, Muenchen (DE); Oliver VEITL, Hohenthann (DE)

(21) Appl. No.: 18/833,986

(22) PCT Filed: Feb. 28, 2023
(86) PCT No.: PCT/EP2023/054998

§ 371 Date: Jul. 29, 2024

(30) Foreign Application Priority Data
Mar. 24, 2022 (DE) 10 2022 107 024.7

(51) Int. Cl. G01M 11/00; G01M 11/02

(52) U.S. Cl. CPC G01M 11/005; G01M 11/0264

(57) ABSTRACT

A method for examining the suitability of a vehicle window for use in a head-up display device includes defining, in relation to human resolution capability, a measuring grid by specifying measuring point distances between discrete measuring points in an actual vehicle window surface to be used as a reflection surface for the head-up display device; acquiring, using deflectrometry, local actual normal vectors of this reflection surface for the specified discrete measuring grid; determining an accompanying local actual line of vision of the head-up display device for each acquired local actual normal vector; and evaluating the actual vehicle window according to a deviation of the determined local actual lines of vision from ideal target lines of vision of the head-up display device, which are each reflected at corresponding surface points of a predetermined ideal target vehicle window.

### BACKGROUND AND SUMMARY

The invention relates to methods for calculating the beam paths in field-of-view display apparatuses for a motor vehicle or another land vehicle, aircraft or watercraft, which are also known by the designation head-up displays (HUDs). Such apparatuses are designed to generate a virtual display image, which is superposed into the field of view of a vehicle occupant, by way of reflection at a partially transparent reflection screen, which is arranged in that person's field of view and in the present case is a windshield, rear window or side window of the vehicle. The invention is directed to the calculation of the beam paths on the basis of a description of the vehicle pane in the form of geometric measurement data. Specifically, the latter are the normal vectors of the window's surface which serves as the reflection surface of the HUD.

A head-up display (HUD) is used to superpose in a vehicle for example speed information and other useful information relating to navigation and vehicle operation or entertainment contents in the form of a virtual image onto the real vicinity image in front of the vehicle which is observed by the driver or another occupant. For this purpose, a HUD in the currently widely used conventional design comprises a projection unit which is housed below a top side of the instrument panel. The projection unit comprises a picture-generating unit, typically a display, for generating a light beam with the desired display content. In addition, the projection unit generally comprises a projection optical unit with one or more mirrors in order to reflect the light beam in a suitable shape and direction onto a vehicle-internal reflection surface of the windshield so that the display contents of the display are superposed via reflection thereon into the field of view of the user (vehicle occupant).

The reflection surface of today's HUD systems of this type takes up approximately 7.5% of the entire windshield inner surface. Due to the continuing development toward larger display surfaces, however, it is expected that up to 50% of the windshield surface will be used in the future for the reflection for superposing virtual contents into the field of view of the occupants, which is where current systems for assessing the representation of this function via the windshield meet their limitations. Furthermore, many newly developed HUD systems require different and further projection depths than in the case of conventional HUDs which have been in wide use until now. To realize this, HUD systems are optimized during their development stage with what are known as ray tracers (and suitable beam path simulation software), which manage the numerical calculation of the beam paths, in terms of the function of the reflection via a free-form surface, in this case the windshield of a vehicle.

Today's software solutions in the field of optics simulation of HUD systems primarily operate numerically since they utilize a free-form surface. These calculation methods are likewise indirectly used in metrology for validating a HUD optical unit. Test patterns are reflected via the free-form surface of the windshield to be examined and then the beam paths are in the background calculated backward, that is to say from the captured camera image to the projector plane or target plane.

The developments in this area show that, for large-scale projections and the examination of the reflective free-form surfaces required herefor with respect to their optics, the free-form surfaces are always captured in their entirety in the form of reconstructed surfaces with curvature and inclination information. Subsequently, numerical simulations with these surfaces are carried out, as in HUD development, and, on the basis thereof, the optics is assessed. However, new findings in this area show that this surface reconstruction generates an additional error source with reference to the actually acquired measurement data. This error may be relevant for the assessment of the imaging quality and shows a difference compared with the imaging which is carried out by a person and would occur using an ideal surface. This problem is shown in FIGS. 1 and 2 for a few representative examples of free-form surfaces which were reconstructed from discrete measurement points, and will be explained below.

FIG. 1 thus shows, by way of example, the distribution of the distances of individual measurement points of a measurement point cloud from a reconstructed surface, which could be calculated on the basis of the measurement points. Three different error distribution diagrams are shown, with each diagram being based on a different measurement data set (continuous contour line for an error distribution of the first pane01, dash-dotted contour line for a second pane02, and a dashed contour line for a third pane03). As can be seen from the three illustrated diagrams, the distribution of the error of the reconstructed pane surfaces varies greatly compared with the actually acquired measurement points from pane to pane and in addition depending on the mathematical reconstruction rule selected.

FIG. 2 shows a schematic cross section of how the error captured in FIG. 1 typically arises. The design surface 1 describes output design data from which an actual surface shape to be examined, which is checked discretely using the measurement points 2, is intended to be produced. The subsequent reconstruction with typical mathematical methods results in a reconstructed free-form surface 3. As is clearly shown in FIG. 2, the deviations thereof from the actual surface that is to be assumed as ideal exceed the permissible tolerance limits 4. Here, the tolerance limits 4 describe the maximum deviation that a reconstructed surface of a reflection optical unit may have before it results in changes in the optical imaging which are visible to the human eye. The common reflection optical unit is here determined primarily by the interaction of the local normal vectors of the free-form surface to be examined.

It is an object of the present invention to specify an alternative and/or improved method for examining a vehicle window, in particular the windshield, for its suitability to be used as a reflection surface in a field-of-view display apparatus, such as a head-up display, with which the abovementioned intrinsic susceptibility to errors of known test methods can be overcome.

This object is achieved by a method and by a corresponding control unit according to the claimed invention. The method is provided for examining a vehicle pane for its suitability to be used in a field-of-view display apparatus, in which a virtual display image is superposed into the field of view of a vehicle occupant via reflection of a light beam with a desired display content at the vehicle pane. All further-reaching features and effects mentioned in the claims and the subsequent description for the method also apply with respect to the control unit, and vice versa.

The field-of-view display apparatus may be in particular a head-up display (HUD) of any type known to a person skilled in the art, in which a vehicle pane is used as the reflection surface. Even though the invention is described herein primarily with respect to a windshield of a motor vehicle, it is in no way limited to this exemplary embodiment. It may also relate to any other vehicle pane, such as side or rear window, and any other land vehicle, aircraft or watercraft.

All spatial orientation terms used herein, such as “above,” “below,” “in front of,” “lateral,” “horizontal,” “vertical” etc., relate to the usual vehicle-fixed Cartesian coordinate system with mutually perpendicular longitudinal, transverse and height axes (x, y, z) of a vehicle or to the Cartesian coordinate system (y, z) of the windshield itself, which corresponds to the vehicle-fixed coordinate system, when the windshield is installed in the vehicle.

It is assumed that the field-of-view display apparatus has a picture-generating unit (PGU), which is formed to generate a light beam with a desired display content and has an image-generating display surface. The picture-generating unit can be any suitable picture-generating apparatus, for example a display such as a liquid crystal display (LCD), LCOS (liquid crystal on silicon) or a self-luminous display based on μLEDs or OLEDs. The display surface mentioned here can also be a scattering or diffusing plate of a picture-generating projector with a scanning light source or an electrically actuable micromirror array. The picture-generating unit or an entire projection unit (which comprises the picture-generating unit and a suitable projection optical unit) of the field-of-view display apparatus can be arranged for example in the interior of the instrument panel or in/on its top side, for example can be installed directly below the top side of the instrument panel, in a manner such that the light beam is cast by the projection unit onto the windshield, which is used as the partially transparent reflection pane. Alternatively, however, the field-of-view display apparatus can also be installed at any other suitable location in the vehicle.

The method comprises the following steps, which can also be carried out in a different sequence than the one stated and possibly with further (intermediate) steps and/or at least in part repeated.

First, a measurement grid of discrete measurement points which is suitable with respect to human resolution is defined on the actual vehicle pane to be examined. This definition in the present case primarily means the setting of suitable measurement point distances between adjacent measurement points along an actual vehicle pane surface which is to be used as the reflection surface of the field-of-view display apparatus.

Next, local actual normal vectors of this reflection surface are deflectometrically captured for the set discrete measurement grid. Capturing here comprises for each individual actual normal vector its three-dimensional vector direction and position, i.e. location, in the reflection surface. The capturing can be carried out in any suitable manner known per se using deflectometry. For example, the actual normal vectors can be determined from the reflection of one or more suitable deflectometry test patterns, which may be arranged at different suitable positions opposite the vehicle pane to be examined, among other things in a picture-generating display surface of the picture-generating unit or a virtual image plane of the field-of-view display apparatus which effectively corresponds thereto. For capturing purposes, one or more suitable cameras can be arranged for example at a position intended for the eyes of the user (i.e. of the vehicle occupant) of the field-of-view display apparatus and/or at other positions opposite the actual vehicle pane. The stated actual normal vectors of the reflection surface which characterize the local inclinations thereof and also curvatures in their entirety can be determined in a manner known per se from the captured reflection recordings of the deflectometry test patterns.

In a further step, for every captured local actual normal vector, an associated local actual viewing ray of the field-of-view display apparatus is determined, i.e. calculated in a suitable manner. One possible exemplary embodiment of this will be described further below with reference to FIG. 5.

Next, a deviation of the determined local actual viewing rays from ideal target viewing rays of the field-of-view display apparatus, which are each reflected at the corresponding surface points of a predetermined ideal target vehicle pane, is determined. On the basis of the determined deviations, it is now possible to calculate the actual vehicle pane with respect to its suitability for use in the field-of-view display apparatus.

The stated measurement point distances can be determined differently in dependence, among other things, on the reflection distance (defined for example as the optical path length from the image-generating display surface to the reflection surface) or the projection depth (defined for example as the distance of the virtual display image from the eye of the user) of the respective field-of-view display apparatus.

One idea of the method proposed herein for evaluating a vehicle pane, in particular windshield, with respect to its HUD performance is to bypass the error-prone step known from the prior art for surface reconstruction as the total surface. Instead, embodiments of the invention propose to perform the calculation of the HUD beam paths solely on the basis of a discrete description of the vehicle pane from the actually determined measurement points of a suitable measurement grid on the pane surface to be examined, wherein the measurement point distances of the suitable measurement grid are defined by the criterion of the resolvability of the resulting changes in the virtual display image for the human eye.

According to one embodiment, when defining the discrete measurement grid, a blur surface element, in particular a blur circle or a blur ellipse, of a user of the field-of-view display apparatus, which is such that changes in the reflection of the light beam at the vehicle pane which occur within the surface of this blur surface element are not perceivable by the user in the virtual display image (due to the limited resolution of the user's eyes), is determined in the reflection surface. In this embodiment, the measurement point distances of the discrete measurement grid are set by virtue of the fact that they do not exceed corresponding linear dimensions of the blur surface element (i.e. linear dimensions that possibly vary along the surface in dependence on the direction and/or in the surface in dependence on the position). In the simplest case, the measurement point distances can be set to be equal for example to the determined linear dimensions of the stated blur surface element.

The blur surface element can be determined here as, for example, an interface of such a viewing beam with the reflection surface of the vehicle pane which is required for or contributes to the formation of an image point on the retina of a user's eye starting from an object point in the image-generating display surface of the field-of-view display apparatus (cf. FIG. 4c).

According to one embodiment, each measurement point in the discrete measurement grid is surrounded by adjacent measurement points. In particular, the measurement points of a respective local planar reflection surface element can be arranged in the corners of a simple rectangular two-dimensional grid (cf. FIG. 3).

In a specific configuration of the present method, for the purpose of determining the associated local actual viewing ray, for each captured local actual normal vector of the reflection surface an associated viewing direction of the user starting from a predetermined center of the user's iris/lens plane 13 (cf. FIG. 5) and the position of the actual normal vector is determined in the reflection surface. From the reflection of the thusly determined local actual viewing ray at a local reflection surface element that is orthogonal to the actual normal vector, in this case an actual image point in a virtual image plane of the field-of-view display apparatus perceived by the user is determined. Next, for evaluating the actual vehicle pane, a deviation of the determined actual image points from target image points, which result from ideal target viewing rays by way of reflection at corresponding surface points of a predetermined ideal target vehicle pane, can be determined. Here, the actual image points and target image points can be compared with one another both individually and also as image point clouds that result from the totality of the countable measurement points of the discrete measurement grid or as suitable subsets thereof.

With respect to the concluding evaluation step, the actual vehicle pane can be used as the reflection pane of the field-of-view display apparatus (head-up display) for example if a deviation which does not exceed a predetermined tolerance deviation is determined. If the predetermined tolerance deviation is exceeded, the actual vehicle pane can be sorted out, for example, or its production method may be modified to eliminate defects that have been determined during the comparison with the ideal target vehicle pane.

According to a further aspect, a control unit is provided which is designed and configured for automatically carrying out at least some steps of the method of the type presented here. For this purpose, for example a corresponding computer program can be installed in the control unit, which computer program, upon execution in the control unit, carries out the evaluation steps described here.

The above aspects of the invention and their specific configuration variants and embodiments will be explained in more detail below additionally with reference to examples shown in the attached drawings. The drawings should be understood to be purely schematic illustrations, i.e. as not to scale.

### BRIEF DESCRIPTION OF THE DRAWINGS

FIG. 1 shows three representative error distribution diagrams for the conventional surface reconstruction of the free-form surfaces of three different panes on the basis of a discrete measurement point cloud.

FIG. 2 shows, in a schematic cross section, a conventional surface reconstruction of a reflective free-form surface which is inspected by way of discrete measurement points and is mathematically calculated starting from a specified initial design surface.

FIG. 3 shows a schematic illustration of a vehicle pane to be evaluated.

FIGS. 4a-4c show schematic lateral cross-sectional views of a vehicle with the vehicle pane from FIG. 3, the partial surface of which is used as the reflection surface of a field-of-view display apparatus with the beam path shown simplified in FIG. 4a in its entirety and by virtual unfolding in FIG. 4b-4c.

FIG. 5 shows a local reflection surface element of the reflection surface from FIG. 3 with a deflectometrically determined associated viewing ray of the vehicle occupant.

FIG. 6 shows a flowchart for one example of a method of the type presented herein.

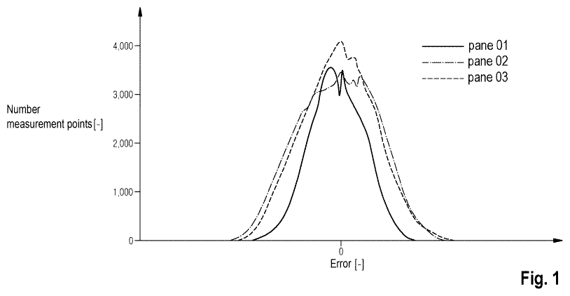

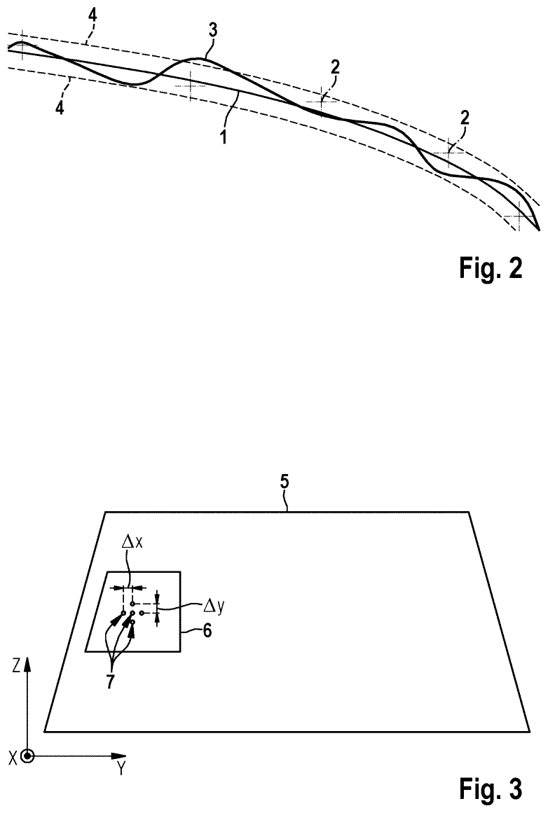

### DETAILED DESCRIPTION OF THE DRAWINGS

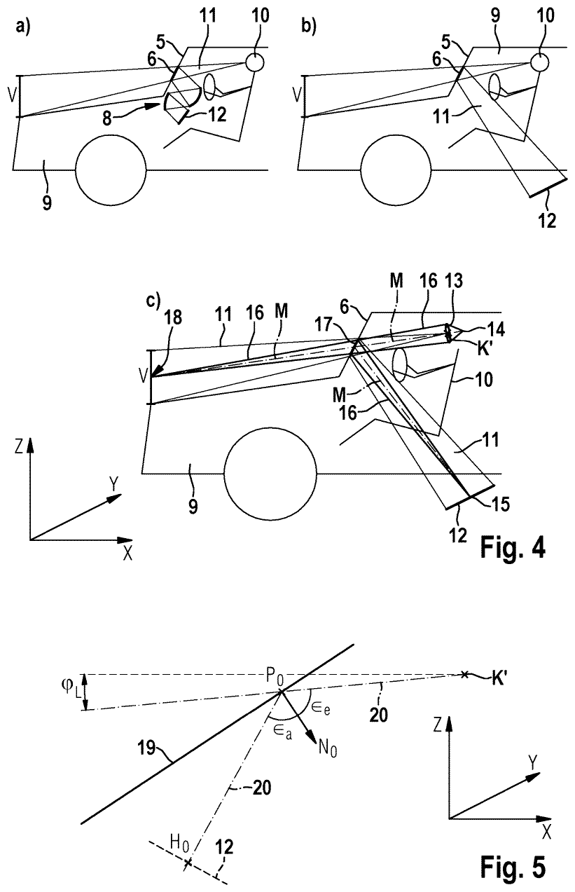

FIG. 3 shows in a greatly simplified schematic illustration a vehicle pane 5 to be evaluated, in this example a windshield, of a vehicle 9, which is shown in greatly simplified schematic lateral cross-sectional views in FIGS. 4a-4c. Evaluated is the suitability of the vehicle pane 5 for a field-of-view display apparatus 8 of the type described above, such as head-up displays, or HUDs for short, in which a surface section of the vehicle pane 5 which is bordered in FIG. 3 is used as reflection surface 6 to reflect a light beam 11 with a desired display content to the eyes of a vehicle occupant 10 for superposing a virtual display image V into the user's field of view. FIG. 5 shows in a lateral cross-sectional view a local reflection surface element 19 of the reflection surface 6 from FIG. 3.

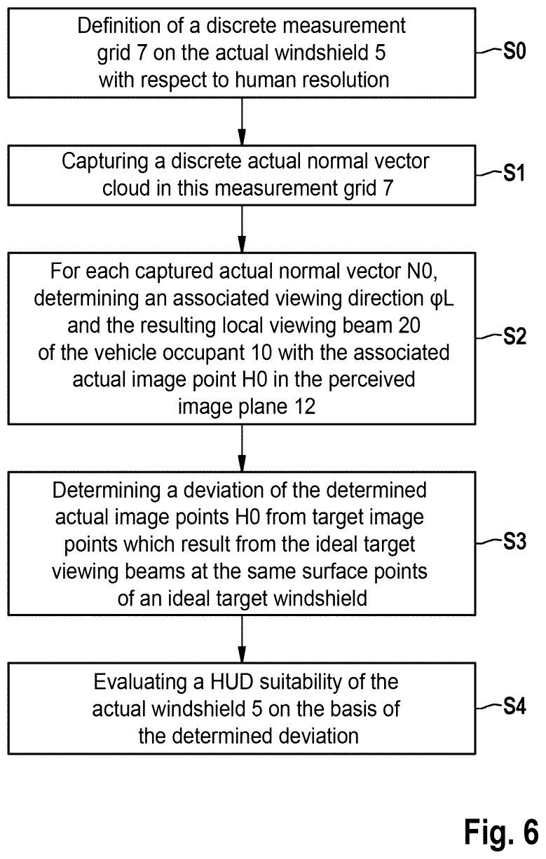

With reference to FIG. 6, an exemplary embodiment for the method of the type presented herein will be described in detail below for the examination by acquisition of the required measurement data and the subsequent preparation and evaluation of the available results. FIG. 6 shows a corresponding flowchart of the method. In order to be able to evaluate the manufactured vehicle pane 5, a comparison between an ideal and the real image presentation in the resulting virtual display image V must be used.

In the field-of-view display apparatus 8, the image of an image-generating display (in FIGS. 4a-4c indicated by its display surface 12) is deflected in a conventional manner via a complex mirror system, typically consisting of a plane mirror and at least two concave mirrors, into the field of view of the driver. The reflection surface 6 of the windshield is used here as one of the two concave mirrors within the mirror system just mentioned. The representation of an ideal optical image presentation of the field-of-view display apparatus 8 starting from the display surface 12, in the form of the geometric optics or the resulting beam paths, by way of a ray tracer requires the geometric shape and position (assumed to be known) of the mirrors mentioned. Within the ray tracer, a tool for simulating the geometric optics of the field-of-view display apparatus 8, the display surface 12 is defined by way of many small or substantially point-shaped light sources which output or emit light beams. Next, the spatial propagation of the light for each of the light sources thus defined through the system is traced until it reaches the observer (user 10).

In order to correctly acquire the measurement data for the postprocessing, a suitable measurement grid 7 is defined in a first step S0. The measurement grid is defined by the distance or distances (Δy, Δz) of a measurement point from another measurement point on the pane surface. In this example, a measurement point has four direct neighboring points, as illustrated in FIG. 3. The individual measurement points in this example, viewed locally, are each arranged in the corners of a rectangular x-y-grid with the grid distances (Δy, Δz), wherein the coordinate system of the vehicle pane 5 coincides in this example with the typical Cartesian vehicle-fixed coordinate system (x, y, z) with the corresponding longitudinal, transverse and height axes of the vehicle 9 (FIGS. 4a-4c).

As shown in the schematic diagrams of the windshield in FIG. 3 and FIGS. 4a-4c, the HUD requires in its vehicle-internal surface a partial region of the surface as the reflection surface 6 for the HUD light rays. The entire reflection surface 6 is divided by the measurement grid 7 into individual discrete measurement points, which are fixed in the z-direction and y-direction by defined distances (Δy, Δz), which can remain the same within the reflection surface 6 or may vary locally. These measurement point distances (Δy, Δz) will be defined in the method presented here, as described below, with reference to the human optics, in the stated step S0, which is used as preparation for the discretized description of the windshield geometry by way of the selected measurement principle.

In order to establish the stated relationship between the selected distance (Δy, Δz) in the measurement grid and the human optics, in the present example the opto-physical relationships of the HUD 8 are simplified in step S0, as is illustrated in FIGS. 4b and 4c.

The aforementioned complex mirror system is illustrated in FIG. 4a. The entire viewing ray volume 11 (also referred to as light beam of the field-of-view display apparatus 8) from the image-generating display surface 12 to the virtual display image V is shown with reference to the vehicle occupant 10 of the vehicle 9.

In order to simplify the beam path of the viewing ray volume 11 for the present method, the beam path, which is folded in reality, is initially virtually unfolded. This unfolding is carried out such that the actual/desired distance (or optical path length) between the vehicle occupant 10 and the virtual display image V is maintained or achieved. In the following description of the method, instead of the actual image-generating display surface 12 from FIG. 4a, a virtual image plane 12 according to FIGS. 4b and 4c obtained by this unfolding of the beam path is therefore viewed, which is perceived by the vehicle occupant 10 as an image plane 18 of the virtual display image V on the left-hand side of the vehicle 9 shown. It is therefore also referred to herein below and in the flowchart of FIG. 6 as “perceived image plane 12.”

As is shown schematically (and greatly enlarged) in FIG. 4c, in the last subset for determining the measurement point distances (Δy, Δz) of the measurement grid 7 of FIG. 3, the geometric viewing beam 16 that is required for the formation of an image point 14 on the retina of the human eye of the vehicle occupant 10 starting from an object point of the display in the perceived image plane 12 is constructed. In FIG. 4c, the viewing beam 16 is constructed on the basis of the knowledge relating to the geometric description of the eye with the appropriate accommodation for perceiving the virtual display image V. The eye in FIG. 4c consists of a lens or iris plane 13 and the retina, wherein the retina is indicated by an image point 14, which also illustrates the distance of the retina from the lens plane 13 at the required focal length for sharply imaging the observed image point. In FIG. 4c, the lens/iris plane 13 is embodied by a narrow ellipse, whereas the focal length is described by the distance between this ellipse and the intersection of the light cone located therebehind, the stated image point 14 on the retina. If the viewing ray cone 16 on the side of the virtual display image Vis continued virtually beyond the windshield, the result is an interface 17 of the cone with the windshield. The local diameter of this interface 17, which from now on will be referred to as the blur element or blur circle of the driver on the windshield, determines in this example the local distance of the measurement points in the measurement grid 7. Any change in the reflection of the light rays within this circle/ellipse surface element cannot be resolved by the vehicle occupant 10. In the following description, mention is made only of the representative central rays M, as illustrated in FIG. 4c, of the individual viewing beams 16 which are required to produce in each case one image point.

In summary, this means for the following metrological capturing of the windshield that the measurement grid 7, that is to say the distance of the individual discrete measurement points in the y-direction and z-direction, respectively, is selected to be smaller than or equal to the diameter of the blur circle through the human optics.

Next, the windshield geometry can be captured discretely using the measurement grid 7 just mentioned in a step S1. The method described in this example relates to measurement results from a deflectometric examination in the form of position-determined normal vectors Ni=N0, N1, N2 . . . N(n−1) (for a total of n measurement points on the windshield). With respect to FIG. 5, this specifically means that at each point Pi=P0, P1, P2 . . . P(n−1) (for the stated n measurement points on the windshield) of the measurement grid 7 from step S0 the local normal vector Ni (for the stated n measurement points on the windshield) of the pane geometry is captured. For an individual position point Pi (in this example position point P0), FIG. 5 shows that these two items of information are given by the stated position point P0 itself, which lies in the local planar reflection surface element 19, and by the normal vector Ni which is orthogonal thereto (NO in this example).

In the next step S2, these two items of measurement information are used for each measurement point of the measurement grid 7 in the vehicle coordinate system (x, y, z) for constructing an associated actual viewing ray 20. Further input parameters for calculation are the node points K′, located at the center of the lens/iris plane 13, the viewing direction of the vehicle occupant 10 in the form of an angle φL to the horizontal axis x, and the position of the perceived image plane 12 in the form of the vector magnitude |H0P0|. Next, taking the optical reflection law ∈e=∈a for the incident and the reflected light ray angles into account, the beam path of the viewing ray 20 for the stated viewing direction of the vehicle occupant 10 reflected at the reflection surface element 19 can be calculated. The reflection surface element 19, which can be assumed to be planar locally, is the result here of the knowledge of the normal vector NO (generally: Ni for an i-th measurement point) and its orthogonality to the reflection surface element 19 and the origin or position P0 (generally: Pi for an i-th measurement point) thereof. With the last calculation step, the direction of the reflected viewing ray 20 is known, and, taking into account the aforementioned vector magnitude, the orientation and the position of the actual image point H0 (or Hi for an i-th measurement point, i.e. an i-th position point Pi, see above) in the image plane 12 observed/perceived by the vehicle occupant can be determined.

The calculation for each further normal vector NO and its position from the deflectometric measurement starting from the node point K′ is carried out in the same way. At the end, the result for each local normal vector NO and the associated reflected viewing ray 20 is, as illustrated in FIG. 5, an observed actual image point H0 in the perceived image plane 12. This image point H0 (image point 15 in FIG. 4c) is obtained as the overlap of the image plane 12 with the viewing ray 20, reflected at the angle Ea, according to FIG. 5.

The actual image points H0 or Hi, which are determined in the last step for each normal vector N0 and Ni, respectively, and perceived by the vehicle occupant 10, can, finally, be compared with the ideal points which result from a simulative implementation of the field-of-view display apparatus 8 with an ideal reflection surface (not illustrated) and be evaluated.

### LIST OF REFERENCE SIGNS

1 Design surface
2 Measurement points for conventional surface reconstruction
3 Reconstructed free-form surface
4 Permissible tolerance limits
5 Vehicle pane
6 Reflection surface
7 Measurement grid
8 Field-of-view display apparatus, specifically also HUD
9 Vehicle
10 Vehicle occupant, also referred to as user
11 Light beam
12 Display surface and perceived image plane
13 Lens plane
14 Image point on the retina
15 Actual image point, also referred to as H0 or H_i at the i-th measurement point
16 Viewing beam
17 Interface
18 Image plane of the virtual display image
19 Local reflection surface element
20 Viewing ray
N0 Actual normal vector or N_i at the i-th measurement point
P0 Position of the normal vector in the reflection surface, surface point or P_i at the i-th measurement point
V Virtual display image
(Δy, Δz) Distances of the measurement points
K′ Node point/center point at the geometric center of the lens plane 13

1.-7. (canceled)

8. A method for examining a vehicle pane for suitability to be used in a field-of-view display apparatus, wherein a virtual display image is superposed into a field of view of a vehicle occupant by way of reflection of a light beam with a desired display content at the vehicle pane, the method comprising:
defining a measurement grid with respect to the human resolution by setting measurement point distances between discrete measurement points in an actual vehicle pane surface that is to be used as a reflection surface of the field-of-view display apparatus;
deflectometrically capturing local actual normal vectors of the reflection surface for the measurement grid;
determining an associated local actual viewing ray of the field-of-view display apparatus for each captured local actual normal vector; and
evaluating the vehicle pane in dependence on a deviation of the determined local actual viewing rays from ideal target viewing rays of the field-of-view display apparatus, which are reflected at corresponding surface points of a predetermined ideal target vehicle pane.

9. The method according to claim 8, wherein:
for defining the measurement grid, a blur surface element is determined in the reflection surface such that changes in the reflection of the light beam at the vehicle pane which occur within the surface of the blur surface element are not perceivable by a user in the virtual display image, and
the measurement point distances of the measurement grid are set such that the measurement point distances do not exceed corresponding linear dimensions of the blur surface element.

10. The method according to claim 9, wherein the blur surface element is a blur circle or a blur ellipse.

11. The method according to claim 16, wherein:
the blur surface element is determined as an interface of a viewing beam with the reflection surface, which viewing beam contributes to formation of an image point on a retina of an eye of the user starting from an object point in an image-generating display surface of the field-of-view display apparatus.

12. The method according to claim 8, wherein:
each measurement point in the measurement grid is surrounded by four adjacent measurement points.

13. The method according to claim 12, wherein:
the measurement points of a respective local planar reflection surface element are arranged in corners of a rectangular two-dimensional grid.

14. The method according to claim 8, wherein:
for determining the local actual viewing ray, for each captured local actual normal vector of the reflection surface, an associated viewing direction of a user starting from a predetermined center point of the user's iris/lens plane and a position of an actual normal vector is determined in the reflection surface;
from the reflection of the local actual viewing ray thus determined at a local reflection surface element, which is orthogonal to the actual normal vector, an actual image point is determined in an image plane of the field-of-view display apparatus which is perceived by the user; and
for evaluating the actual vehicle pane, a deviation of the actual image points from target image points resulting from ideal target viewing rays is determined by way of reflection at the corresponding surface points of a predetermined ideal target vehicle pane.

15. The method according to claim 8, wherein:
when a tolerance deviation does not exceed a predetermined tolerance deviation, the vehicle pane is used as the reflection pane of the field-of-view display apparatus; and
when the tolerance deviation exceeds the predetermined tolerance deviation, the vehicle pane is sorted out or a production method is modified to eliminate defects which have been detected during a comparison with the ideal target vehicle pane.

16. A control unit which is configured to automatically carry out the method according to claim 8.
